(19) United States
(12) Patent Application Publication
(10) Pub. No.: US 2015/0186152 A1
(43) Pub. Date: Jul. 2, 2015

(54) SENSING AND ASSISTING COMPUTING DEVICE CONNECTIONS

(71) Applicants: Gangatharan Jothiswaran, Bangalore (IN); Prasanna Krishnaswamy, Bangalore (IN); Arvind S, Bangalore (IN); Gokul V. Subramaniam, Bangalore (IN)

(72) Inventors: Gangatharan Jothiswaran, Bangalore (IN); Prasanna Krishnaswamy, Bangalore (IN); Arvind S, Bangalore (IN); Gokul V. Subramaniam, Bangalore (IN)

(21) Appl. No.: 14/142,679

(22) Filed: Dec. 27, 2013

(51) Int. Cl. G06F 9/44; G06F 3/0481

(52) U.S. Cl. CPC G06F 9/4446; G06F 3/0481

(57) ABSTRACT

Described herein are a system and method for sensing and assisting connections to a computing device. The method includes identifying an intention to make a connection with the computing device. The method also includes determining one or more parameters for the connection based on identifying the intention. Additionally, the method includes presenting information indicating a location of the connection.

### TECHNICAL FIELD

The present techniques relate generally to sensing attempted connections to computing devices and, to helping to complete the attempted connections.

### BACKGROUND

Computing devices like sub-notebooks, 2-in-1's, portable all in one systems, docking stations, smart displays, TVs, and so on, include various types of connector sockets, ports, and various controls. Attempting to plug the corresponding connectors into these sockets, access these controls, and so on, can be cumbersome, cause false interactions, and conflict with other system capabilities. For example, these various devices may visibly conceal their sockets, ports, and so on, for aesthetic reasons. However, this makes it challenging to actually access a socket, for example, to insert a connector. Further, connecting to a port is challenging in many cases due to obstacles near the computing device. For example, some systems are mounted on walls, or kept close to heavy furniture. With the possibility that attempting to force a connection into the wrong socket may dismount the device, tip the device or nearby furniture over, etc., accessing concealed sockets, ports, and controls may be cumbersome and hazardous.

### BRIEF DESCRIPTION OF THE DRAWINGS

FIG. 1 is a block diagram of an example computing device for sensing and assisting computing device connections, in accordance with embodiments.

FIG. 2 is a process flow diagram of a method for sensing and assisting computing device connections, in accordance with embodiments.

FIGS. 3A-3B are block diagrams of an example computing device that senses and assists computing device connections, in accordance with embodiments.

FIGS. 4A-4B are block diagrams of an example computing device that senses and assists computing device connections, in accordance with embodiments.

FIG. 5 is a block diagram depicting an example of a tangible, non-transitory computer-readable medium to sense and assist computing device connections, in accordance with embodiments.

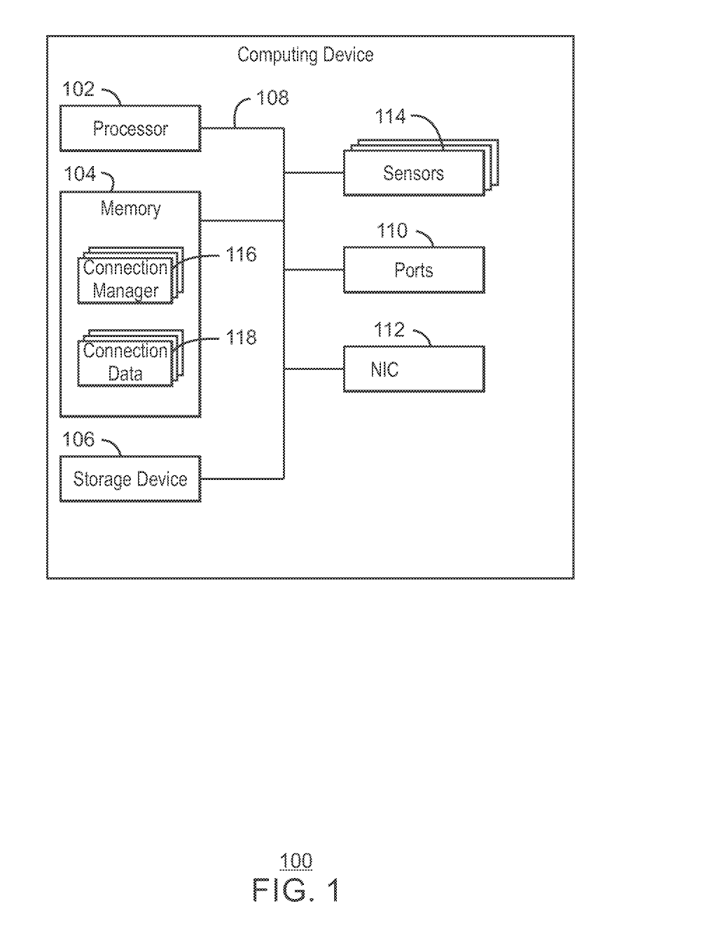

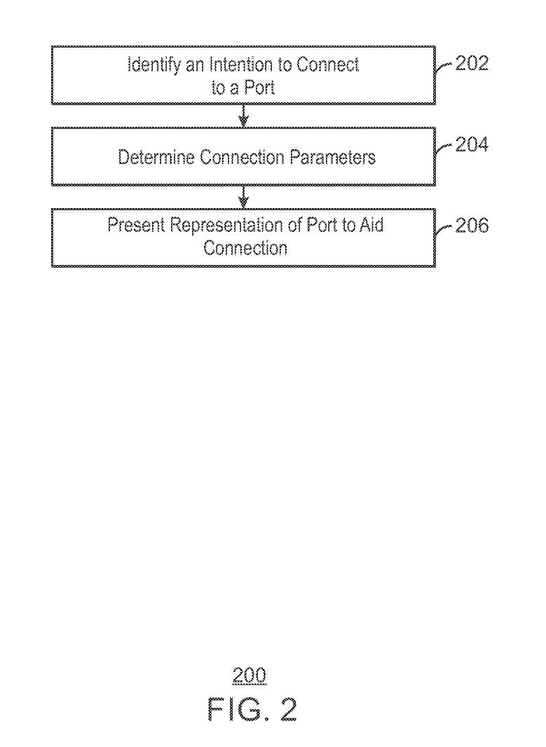

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

While typical computing devices may label the sockets, ports, and controls, the labels may detract from the aesthetics of the device. However, examples of the techniques described herein aid the connection of various devices to the various connections, ports and controls located on a display device. In this way, users may be aided in accessing the sockets, I/O ports, and controls without compromising the aesthetics of the device, thereby improving the user experience.

Examples of the techniques described herein may aid users in locating otherwise concealed sockets, I/O ports, and controls without blindly reaching for them. In some examples, the sockets, I/O ports, and controls reside in one or more sides of a display device, the base of a computing device, such as an all-in-one device, or the back of a computing device, among other locations. Further, examples of the techniques described herein may be included in docking stations, portable all in one personal computers (PCs), 2 in 1 systems, smart televisions, and smart phones, among others.

FIG. 1 is a block diagram of an example computing device 100 for sensing and assisting computing device connections, in accordance with embodiments. The computing device 100 having a processor 102, a memory 104, a storage device 106 comprising a non-transitory computer-readable medium, connected through a bus 108 that also connects with various ports 110, a network interface card 112, and sensors 114. The ports 110 include various sockets, ports, and controls connecting various devices, such as input/output (I/O) devices, to the computing device 100. The NIC 112 may provide access to various networks, including local area networks, wide area networks, collections of networks, and so on. In one embodiment, the NIC 112 provides access to the Internet. The sensors 114 include, but are not limited to cameras, radio frequency identification tag readers, microphones, motion detectors, and so on. In one embodiment, the microphone is used for voice commands to display the location of one or more sockets, ports 110, and controls. The memory 104 includes a connection manager 116 and connection data 118. The connection manager 116 may be logic, such as, hardware logic. In some embodiments, the connection manager 116 is a set of instructions in memory 104 that, when executed, direct the processor 102 to perform operations including identifying, based on the sensors 114, an intention to connect to one of the ports 110 of the computing device 100. The connection manager 116 determines connection parameters based on connection data 118. Whether the connection manager 116 is implemented as logic, an integrated circuit, or a set of instructions to be carried out by the processor 102, the connection manager 116 presents a representation of the connector used in the connection attempt and a corresponding port 110 for the connector. The representation indicates the location of the port 110 on the computing device 100.

The processor 102 may be a main processor that is adapted to execute the stored instructions. The processor 102 may be a single core processor, a multi-core processor, a computing cluster, or any number of other configurations. The processor 102 may be implemented as Complex Instruction Set Computer (CISC) or Reduced Instruction Set Computer (RISC) processors, x86 Instruction set compatible processors, multi-core, or any other microprocessor or central processing unit (CPU). The memory 104 can include random access memory (RAM) (e.g., static random access memory (SRAM), dynamic random access memory (DRAM), zero capacitor RAM, Silicon-Oxide-Nitride-Oxide-Silicon SONOS, embedded DRAM, extended data out RAM, double data rate (DDR) RAM, resistive random access memory (RRAM), parameter random access memory (PRAM), etc.), read only memory (ROM) (e.g., Mask ROM, programmable read only memory (PROM), erasable programmable read only memory (EPROM), electrically erasable programmable read only memory (EEPROM), etc.), flash memory, or any other suitable memory systems. The main processor 102 may be connected through a system bus 108 (e.g., Peripheral Component Interconnect (PCI), Industry Standard Architecture (ISA), PCI-Express, HyperTransport®, NuBus, etc.) to components including the memory 104, the storage device 106, ports 110, NIC 112, and sensors 114. The block diagram of FIG. 1 is not intended to indicate that the computing device 100 is to include all of the components shown in FIG. 1. Further, the computing device 100 may include any number of additional components not shown in FIG. 1, depending on the details of the specific implementation.

In another embodiment, the connection manager 116 displays a current status of a port 110 based on information other than intent to access the ports 110. For example, information can be displayed based on the devices in proximity to a port 110. If a smartphone or digital camera is brought close to the computing device 100, possible locations for connecting the phone and camera to the computing device 100 are displayed. Additionally, connection types may be displayed, e.g., universal serial bus (USB). The information can also be based on uses of the computing device 100. For example, if the computing device 100 is accessing a cloud storage website, the connection manager 116 displays possible ways to upload data from devices that can be connected to the computing device 100. Additionally, the connection manager may display ways to upload data from digital media management applications.

FIG. 2 is a process flow diagram of a method 200 for sensing and assisting computing device connections, in accordance with embodiments. The method 200 is performed by the connection manager 116, and begins at block 202, where the connection manager 116 identifies an intention to connect to a port 110. Identifying an intention to connect to the port 100 include sensing a user's intention to plug a connector in the port 110. Sensing the intention of a user to plug a device into a socket can include detecting the activation of any switch or button such as a physical switch, detecting capacitive information, detecting input from a software GUI, voice command, or presenting a RFID tagged socket or a sensor designed to sense sockets or plug-in devices that approach a display device. The socket sensing may include a capability to sense the type, location and orientation of a device or socket being plugged into a socket in a device. In other embodiments, a device being plugged into a socket may include radio frequency (RF) tags associated with a specific type of port 110.

At block 204, the connection manager 116 determines connection parameters. The connection parameters may be stored in the connection data 118. Additionally, the connection manager 116 may check the availability of unused ports 110, and provide guidance related to the location of the connector in relation to the port 110.

At block 206, the connection manager 116 presents a representation of the port 110 to aid connection. Additionally, the representation may indicate the location of the connector in relation to the port 110. In one embodiment, the connection manager 116 identifies the intent to use the ports 110 of a computing device, and displays intelligent real time information based on sensing the intent to use the ports 110. For example, the real time information may include the location of a socket (a physical indicator to guide the user), a state of the socket (e.g., in use/closed, not in use/open, offline, etc.), and a result of the connection (e.g., idle, busy, connected etc.). The connection manager 116 may display the real-time information before, during, and after the connection is completed. In another embodiment, a screen overlay appears on an all-in-one's display device. The overlay shows the locations of the ports 110 of the device 100. In one embodiment, the connection manager 116 queries a port status of each physical interface from an operating system, and displays a list of the ports 110 that are available.

In other embodiments, socket information associated with an RF tag may be displayed. Similarly a voice activated command could request a display of available sockets in a device. For example, a user may provide a voice command such as, “Where do I connect a USB device?” and the display may indicate the location of available USB ports.

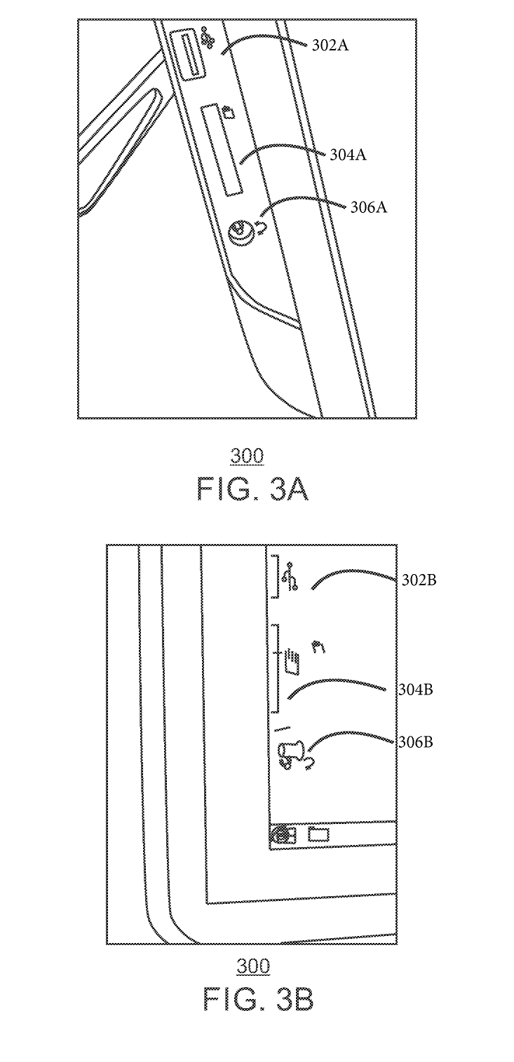

FIGS. 3A-3B are block diagrams of an example computing device 300 that senses and assists computing device connections, in accordance with embodiments. FIG. 3A is a side view, and FIG. 3B is a front view. The computing device 300 includes ports 302A, 304A, 306A. The ports 302A, 304A, 306A are not readily visible from the front view. In one embodiment, the connection manager 116 detects events that indicate the intention to plug a connector into one of the ports 110. These events include, but are not limited to pressing a physical switch, a soft switch, and menu selections in a system tray.

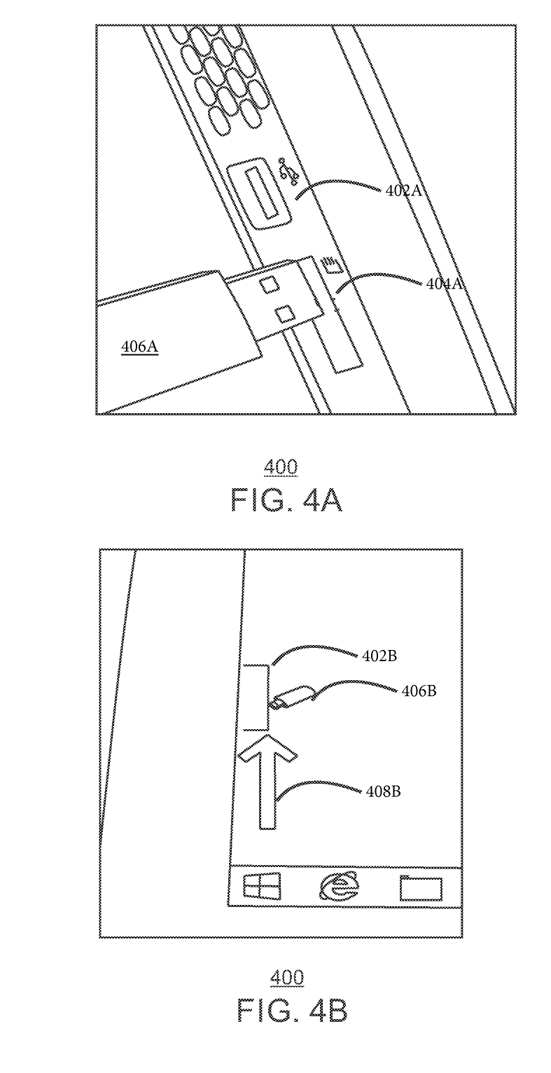

FIGS. 4A-4B are block diagrams of an example computing device 400 that senses and assists computing device connections, in accordance with embodiments. Embodiments of the present techniques provide the benefit of showing port locations automatically upon detecting a connector 406A, for example, being brought in proximity with one of the ports 402A, 404A. In one embodiment, detection by the sensors 114 triggers the display of an on-screen overlay to assist the connection. For example, the arrow 408 guides the user to the appropriate location 402B of the port 402A. The sensor 114 can also be used to sense a type of connector, the connector's orientation, and the connector's relative location to a port. In one embodiment, the connection manager 116 uses a microphone to detect voice commands for displaying the location of one or more ports.

For example, a connection manager 116 may sense an attempt to make a connection. In one embodiment, the connection manager 116 senses a human hand reaching for a volume control, and displays an onscreen overlay pointing the hand to the correct location for the volume controls. In another embodiment, the connection manager 116 senses a USB connector based on an image of the connector captured during an attempted connection, and displays on an onscreen overlay showing the USB connector in its current location, and pointing the direction to move the USB connector to an available USB socket. Additionally, one of the sensors 114 may provide the current location of a connector with respect to the computing device 100. Accordingly, the connection manager 116 may present real time feedback to guide the connector to the port 110. The feedback can be a combination of visual, audio and LED feedback, among others.

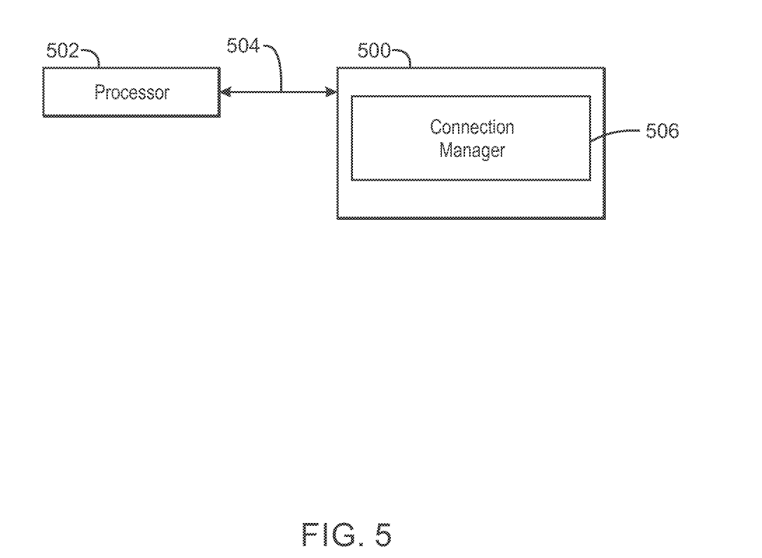

FIG. 5 is a block diagram depicting an example of a tangible, non-transitory computer-readable medium to sense and assist computing device connections, in accordance with embodiments. The tangible, non-transitory, computer-readable medium 500 may be accessed by a processor 502 over a computer bus 504. Furthermore, the tangible, non-transitory, computer-readable medium 500 may include computer-executable instructions to direct the processor 502 to perform the steps of the current method. The various software components discussed herein may be stored on the tangible, non-transitory, computer-readable medium 500, as indicated in FIG. 5.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. An apparatus for sensing and assisting connections to a computing device, comprising:
a display device;
a plurality of ports;
a processor; and
a memory comprising instructions the processor executes to:
identify an intention to make a connection with one port of the ports;
determine one or more parameters for the connection based on identifying the intention; and
present information on the display device indicating a location of the one port based on the determined parameters.

2. The apparatus of claim 1, the intention to make a connection being identified by determining that a connector for the connection is in proximity with at least one of the ports.

3. The apparatus of claim 1, the intention to make a connection being identified by determining that a connection is being attempted based on a detection by a sensor.

4. The apparatus of claim 3, the sensor being an infrared sensor and a connector for the connection comprising an infrared tag detected by the infrared sensor.

5. The apparatus of claim 3, the sensor being a motion sensor, the motion sensor detecting a connector in proximity with a port of the computing device.

6. The apparatus of claim 3, the sensor being a camera, the camera detecting a connector in proximity with a port of the computing device.

7. The apparatus of claim 3, the information being presented in response to an interrupt triggered by the sensor.

8. The apparatus of claim 1, wherein representing information comprises displaying an onscreen overlay on the computing device, the onscreen overlay comprising a location of a port for the connection, and a type of the connection.

9. The apparatus of claim 8, the onscreen overlay comprising a real-time representation of a connector for the connection, a location of the connector, and an indicated direction for moving the connector toward the one port for the connection.

10. The apparatus of claim 1, the real-time representation of the connector comprising dynamic information about a port for the connection, the connector, and the connection before, during, and after the connection.

11. A method of sensing and assisting connections to a computing device, comprising:
identifying an intention to make a connection with the computing device;
determining one or more parameters for the connection based on identifying the intention; and
presenting information indicating a location of the connection.

12. The method of claim 11, identifying the intention to make a connection comprising determining that a connector for the connection is in proximity with one or more ports.

13. The method of claim 11, identifying the intention comprising determining that a connection is being attempted based on detection by a sensor.

14. The method of claim 13, the sensor being an infrared sensor and a connector for the connection comprising an infrared tag detected by the infrared sensor.

15. The method of claim 13, the sensor being a motion sensor, the motion sensor detecting a connector in proximity with a port of the computing device.

16. The method of claim 13, the sensor being a microphone, the microphone detecting a voice command requesting the information indicating the location of the connection.

17. The method of claim 13, the information being presented in response to an interrupt triggered by the sensor.

18. The method of claim 11, wherein representing information comprises displaying an onscreen overlay on the computing device, the onscreen overlay comprising a location of a port for the connection, and a type of the connection.

19. A non-transitory computer readable medium including code, when executed, to cause a processing device to:
identify an intention to make a connection with one port of the ports based on a sensor detection of a connector for the connection;
determine one or more parameters for the connection based on the sensor detection, the parameters comprising a location of the one port, a location of the connector relative to the one port, and a type of the connection; and
display an onscreen overlay on a display of a computing device, the onscreen overlay comprising the location of the one port, the location of the connector relative to the port, and the type of the connection based on the determined parameters.

20. A system, comprising:
a storage element to be updated to hold a representation of plurality of ports of the system;
control logic coupled to the storage element to identify an intention to make a connection with one port of the ports based on a sensor detection of a connector for the connection;
control logic coupled to the storage element to determine one or more parameters for the connection based on the sensor detection, the parameters comprising a location of the one port, a location of the connector relative to the one port, and a type of the connection; and
control logic coupled to the storage element to display an onscreen overlay on a display of a computing device, the onscreen overlay comprising the location of the one port, the location of the connector relative to the port, and the type of the connection based on the determined parameters.
